(19) United States
(12) Patent Application Publication
(10) Pub. No.: US 2007/0260910 A1
(43) Pub. Date: Nov. 8, 2007

(54) Method and apparatus for propagating physical device link status to virtual devices

(76) Inventors: Vinit Jain, Austin, TX (US); Jorge Rafael Nogueras, Austin, TX (US)

Correspondence Address: IBM CORP (YA);C/O YEE & ASSOCIATES PC, P.O. BOX 802333, DALLAS, TX, 75380, US

(21) Appl. No.: 11/397,845

(22) Filed: Apr. 4, 2006

(51) Int. Cl. G06F 11/00

(52) U.S. Cl. 714/4

(57) ABSTRACT

A method, apparatus, and computer instructions are provided for propagating a physical device's link status to one or more virtual devices associated with the physical device. Link status information about the physical device indicating a failure in the physical device is identified using partition management firmware. The link status information about the physical device is propagated by partition management firmware to one or more virtual devices associated with the physical device. The logical partition using the virtual device use the virtual device link status to determine if a physical link to an outside network is down, and take appropriate remedial actions as may be necessary.

### BACKGROUND OF THE INVENTION

1. Technical Field

The present invention relates generally to an improved data processing system and in particular to an improved method and apparatus for processing data. Still more particularly, the present invention provides a method and apparatus for propagating link status information from a physical Ethernet adapter to virtual Ethernet adapters in a data processing system with logical partitions (LPAR).

2. Description of Related Art

In data processing systems that can be divided into logical partitions (LPAR), virtual Ethernet adapters (VEA) can be used to provide network connectivity between logical partitions. As far as the operating systems of the logical partitions are concerned, virtual Ethernet adapters behave just like any regular physical Ethernet adapters (PEA). A partition management firmware connects the various logical partitions and provides the network connectivity among them. Hypervisor is an example of such partition management firmware. When the network activity is limited to activity among the logical partitions, no physical counterpart to the virtual Ethernet adapters is required. For this reason, a virtual Ethernet adapter cannot fail in ways a physical Ethernet adapter can fail, for example, due to hardware failure, unplugged Ethernet cable, and faulty switches.

However, if any logical partition wants to communicate with a data processing system outside the network provided by the partition management firmware layer such as Hypervisor, a physical device, like a physical Ethernet adapter, is required. When a physical Ethernet adapter becomes a part of the communication network involving virtual Ethernet adapter and logical partitions, the vulnerabilities due to the potential for the physical link to the outside network to fail must be accommodated. Currently, when a physical Ethernet adapter fails, or a physical link to the outside network fails, a virtual Ethernet adapter does not know about it. As a result, the logical partition using the virtual Ethernet adapter does not know about the physical link failure either. If a logical partition can become aware of the failure of the physical Ethernet adapter or the physical link through the virtual Ethernet adapter, the logical partition can take actions to accommodate such failures, and utilize already provided methods within the logical partition configuration to use alternate means to reestablish outside network communication.

Presently, the virtual Ethernet adapters in the logical partitions have no way of knowing that a physical link has been disrupted, or has gone “down.” The virtual Ethernet adapters do not know the link status of the physical Ethernet adapter primarily because the virtual Ethernet adapters and physical Ethernet adapter are located on different logical partitions. Therefore, any upper layer in the logical partitions, for example, the Internet Protocol (IP) interface, also has no way of knowing that a link has gone “down.” The lack of this information causes the logical partition's operating system to assume that the virtual Ethernet adapter in use is operating normally, and prevents high-availability solutions such as High Availability Cluster Multi-Processing (HACMP), and Link Aggregation, from reacting to a disrupted physical link.

Therefore, it would be advantageous to have an improved method, apparatus, and computer instructions for propagating the link status of a physical Ethernet adapter to the virtual Ethernet adapter so the logical partition and other upper layers in the logical partitions can take appropriate actions to handle a disrupted physical link to the outside network.

### SUMMARY OF THE INVENTION

The illustrative embodiments provide a computer implemented method, apparatus, and computer usable program code for managing adapters in a logically partitioned data processing system. The partition management firmware identifies a physical adapter that is associated with, and is being used by, a set of virtual adapters. The partition management firmware identifies a link status of the physical adapter indicating a failure in the physical adapter, and sends the link status to the set of associated virtual adapters to be the link status of each virtual adapter in the set of virtual adapters.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the illustrative embodiments may be implemented;

FIG. 2 is a block diagram of an exemplary logical partitioned platform in which the illustrative embodiments may be implemented;

FIG. 3 is a block diagram illustrating an logical partition data processing system connecting to an outside network in accordance with an illustrative embodiment;

FIG. 4 is a flowchart illustrating the steps of propagating a physical Ethernet adapter link status to associated virtual Ethernet adapters in accordance with an illustrative embodiment; and

FIG. 5 is a flowchart illustrating how an upper layer in a logical partition can use the virtual Ethernet adapter link status to manage data flow through the virtual Ethernet adapter in accordance with an illustrative embodiment.

### DETAILED DESCRIPTION OF THE PREFERRED EMBODIMENT

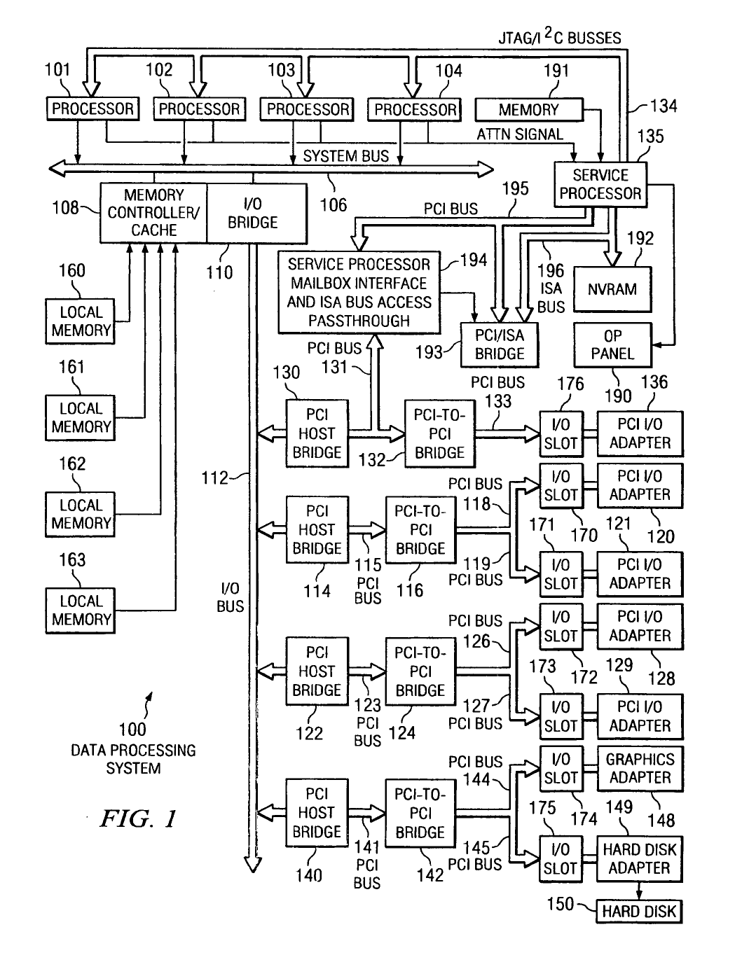

With reference now to the figures, and in particular with reference to FIG. 1, a block diagram of a data processing system in which the illustrative embodiments may be implemented is depicted. Data processing system 100 may be a symmetric multiprocessor (SMP) system including a plurality of processors 101, 102, 103, and 104, which connect to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects for a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Linux or OS/400 operating system may be operating within logical partition P3.

Peripheral component interconnect (PCI) host bridge 114 connected to I/O bus 112 provides an interface to PCI local bus 115. A number of PCI input/output adapters 120-121 connects to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128-129. PCI I/O adapters 128-129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for a PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATS, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the illustrative embodiments.

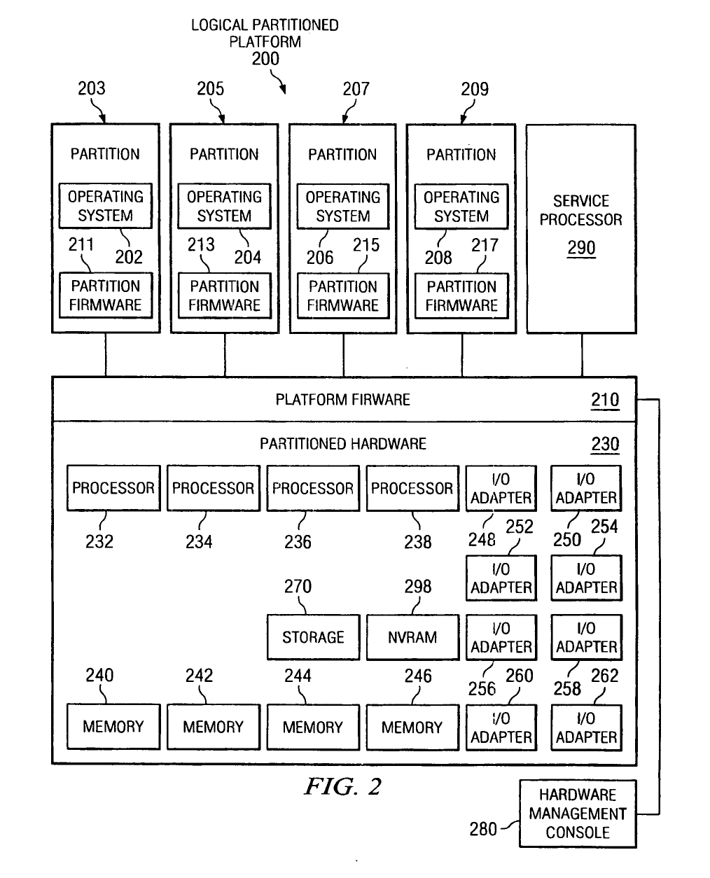

With reference now to FIG. 2, a block diagram of an exemplary logical partitioned platform is depicted in which the illustrative embodiments may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor. OS/400 is used only as an example in these illustrative embodiments. Of course, other types of operating systems, such as AIX and linux, may be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

Logical partitions can communicate among themselves using virtual Ethernet adapters. Logical partitions needing access to an outside network make use of physical Ethernet adapters (PEA) via the virtual Ethernet adapters. The present state of technology does not provide a way to inform a logical partition about the status of a virtual Ethernet adapter based link to an outside network. Presently, the virtual Ethernet adapters in the logical partitions have no way of knowing that a physical link has been disrupted, or has gone “down.” The virtual Ethernet adapters do not know the link status of the physical Ethernet adapter primarily because the virtual Ethernet adapters and physical Ethernet adapter are located on different logical partitions. Therefore, any upper layer in the logical partitions, for example, the Internet Protocol (IP) interface, also has no way of knowing that a link has gone “down.” The lack of this information causes the logical partition's operating system to assume that the virtual Ethernet adapter in use is operating normally, and prevents high-availability solutions such as High Availability Cluster Multi-Processing (HACMP), and Link Aggregation, from reacting to a disrupted physical link.

Aspects of the illustrative embodiments provide a method and apparatus for propagating the link status of a physical Ethernet adapter to a virtual Ethernet adapter. Through the aspects of the illustrative embodiments, the logical partitions can learn the status of a link to an outside network from the virtual Ethernet adapters located on the partition. Traditionally, logical partitions determine if a physical link is up or down by sending a “ping” request to a well-known fixed IP address on the outside network. The illustrative embodiment also removes the requirement of a fixed IP address to ping from the logical partition and analyze the ping results to determine whether a link to outside network is up or down. The illustrative embodiment removes the extra network bandwidth required for ping method, is much faster than the ping method, and allows the upper layers to behave in the way they are already used to once they detect that a physical link is down. For example, a method designed to failover in the event of a physical link failure can be used to failover when a virtual Ethernet adapter reports a “down” link status as well.

The aspects of the illustrative embodiments provide yet another advantage over the ping method. The ping method can occasionally cause a false failover due to a spurious delay in a ping return that is not due to a physical Ethernet adapter failure. The illustrative embodiments cause no such false failovers because the invention does not depend on ping returns.

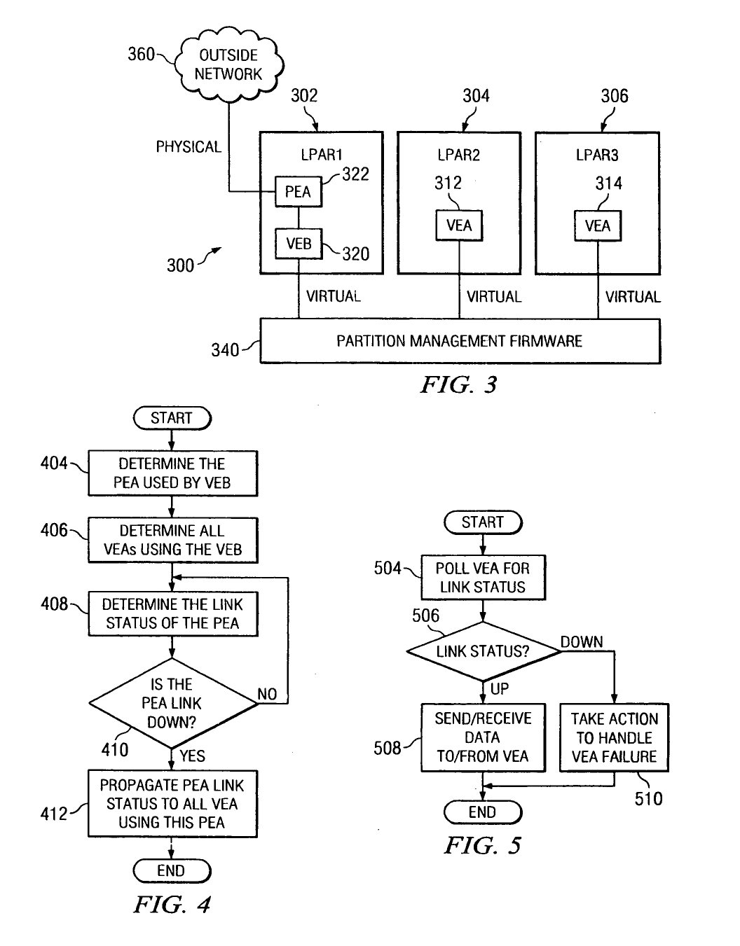

Turning now to FIG. 3, a block diagram illustrating a logical partition data processing system connecting to an outside network is depicted in accordance with a illustrative embodiment. In this example, logical partitions 302, 304, and 306 are shown, each logical partition being similar to any one of 203, 205, 207, and 209 in FIG. 2. Logical partitions 304 and 306 contain virtual Ethernet adapters 312, and 314.

In a data processing system using logical partition, each logical partition contains virtual devices such as virtual Ethernet adapter or a virtual Ethernet bridge (VEB). Virtual devices such as virtual Ethernet adapter enable logical partitions to communicate among themselves using partition management firmware, such as Hypervisor. IBM's Hypervisor product is used here only as an example of partition management firmware. Such use is not intended to limit the illustrative embodiments to just the Hypervisor product from IBM. Persons of ordinary skill in the art will appreciate that other partition management firmware products can be used to practice the illustrative embodiments.

A logical partition may want to communicate with a data processing system in outside network 360. Outside network is a network other than partition management firmware 340 that logical partition is connected to. When such connectivity to outside network is desired, virtual Ethernet bridge 320 is required. Virtual Ethernet bridge 320 is a software component that bridges, or acts to communicate data between, a virtual network and a physical network, and vice versa. Typically, all data flowing from virtual Ethernet adapters and physical Ethernet adapter, and back, passes through the virtual Ethernet bridge. Partition management firmware 340 connecting the various logical partitions 302, 304, and 306, is an example of a virtual network, and outside network 360 is an example of a physical network in accordance with an illustrative embodiment. In order to accomplish this function, virtual Ethernet bridge 320 has access to at least one physical Ethernet adapter 322 to be able to communicate to the outside network 360.

Of the various logical partitions that may exist in a logical partition configuration, one logical partition is designated to have a virtual Ethernet bridge in these examples. Although only one virtual Ethernet bridge is illustrated, more than one virtual Ethernet bridge may exist in logical partition configurations. The illustrated embodiment only refers to one such designated logical partition on which one such virtual Ethernet bridge is located. Logical partition 302 is shown as the designated logical partition that has virtual Ethernet bridge 320. Physical Ethernet adapter 322 with which virtual Ethernet bridge 320 connects is also located on this designated logical partition 302. The virtual Ethernet bridge exists in one logical partition, and all other logical partitions may use their virtual Ethernet adapters to connect to the same virtual Ethernet bridge via partition management firmware to communicate with outside network according to the illustrative embodiments.

A logical partition sending data to an outside network sends the data to the virtual Ethernet adapter located on that partition. The virtual Ethernet adapter communicates with the partition management firmware to communicate this data to the virtual Ethernet bridge located on a different partition. Once the data arrives at the virtual Ethernet bridge, the data is routed to the physical Ethernet adapter associated with the virtual Ethernet bridge. The physical Ethernet adapter places the data on the outside network to send it to the data's final destination using a selected data communication protocol such as TCP/IP. Conversely, when outside network sends data to a logical partition, the data is sent to a physical Ethernet adapter located on one of the logical partitions. The physical Ethernet adapter communicates this data to the virtual Ethernet bridge located on the same partition. Once the data arrives at the virtual Ethernet bridge, the data is routed to the virtual Ethernet adapter located on the destination logical partition.

Turning now to FIG. 4, a flowchart illustrating the operation of propagating physical Ethernet adapter link status to associated virtual Ethernet adapters is depicted in accordance with an illustrative embodiment. The process illustrated in FIG. 4 may be implemented in a firmware component, such as partition management firmware 340 as shown in FIG. 3.

The process begins by determining whether a physical Ethernet adapter is being used by a virtual Ethernet bridge and identifies the physical Ethernet adapter (Step 404). One of the ways in which this identification can be performed is by using the binding information for the virtual Ethernet bridge. The binding information reveals if the virtual Ethernet bridge is “bound” to, and using, a physical Ethernet adapter. Next, the process identifies all virtual Ethernet adapters using the virtual Ethernet bridge (step 406). One or more virtual Ethernet adapters may exist in a logical partition configuration using the virtual Ethernet bridge. Through the determination in step 406, the partition management firmware determines which virtual Ethernet adapters and which logical partitions are engaged in communication with outside network, like the outside network 360 shown in FIG. 3.

Next, the process determines the link status of physical Ethernet adapter (step 408). One way of determining the link status of a physical Ethernet adapter would be to use Common Data Link Interface compliant (CDLI-compliant) Ethernet adapters that can return asynchronous status notification to upper layers stating that their link has gone “down” or come “up.” Existing data processing systems utilize these capabilities of physical Ethernet adapters today. This method for determining the link status is described here only as an exemplary illustration, and is not meant to be limiting on the illustrative embodiments.

Next, process determines whether the link status reported by physical Ethernet adapter reflects that the link is “down” (step 410). The process repeatedly checks physical Ethernet adapter as long as physical Ethernet adapter reports link status as “up” (“NO” output of step 410). If the process determines from physical Ethernet adapter link status that the link to outside network is “down” (“YES” output of step 410), the process notifies all virtual Ethernet adapters that are using the physical Ethernet adapter through the virtual Ethernet bridge about the “down” link status (step 412). Typically, partition management firmware will signal the link status to the device drivers of virtual devices. The device driver may accept the link status signaled by the partition management firmware and further act upon it depending on the operating system on which the device driver is implemented.

Upper layers of logical partitions can then utilize the virtual Ethernet adapter link status just as if the upper layers were receiving this link status notification from a physical Ethernet adapter. Upper layers, such as an IP Interface, already implement methods for determining a physical Ethernet adapter for link status. One such method is polling the physical Ethernet adapter. By polling the physical Ethernet adapter, the upper layers know whether the physical Ethernet adapter link is up or down. Even though the same polling methods could be used with virtual Ethernet adapters, upper layers do not poll the virtual Ethernet adapter today because the present state of the art does not support link status for virtual Ethernet adapters. With the aspects of the illustrative embodiment, upper layers will be able to poll all adapters using existing methods, regardless of whether the adapter is a physical Ethernet adapter or a virtual Ethernet adapter because link status will be available from either types of adapters.

Turning now to FIG. 5, a flowchart illustrates how an upper layer in a logical partition would utilize the link status of a virtual Ethernet adapter. The process illustrated in FIG. 4 may be implemented in a firmware component, such as partition management firmware 340 as shown in FIG. 3.

The process begins by upper layer polling virtual Ethernet adapter for link status (Step 504). Upper layer can poll virtual Ethernet adapter for link status just as existing upper layer methods do for polling a physical Ethernet adapter. If the link status if the virtual Ethernet adapter is “up,” (UP branch of step 506), the process uses the virtual Ethernet adapter to send and receive data to and from outside network 360 (step 508). If the link status of virtual Ethernet adapter is “down,” (DOWN branch of step 506), the process takes action to handle the virtual Ethernet adapter failure and finds alternate routes for sending and receiving data to and from outside network 360 (step 510). Upper layer can use already existing methods for handling physical Ethernet adapter failure to accomplish step 510.

The illustrative embodiment provides a mechanism for providing link status information for virtual Ethernet adapters in logical partitioned environments. The link status for virtual Ethernet adapters is similar to the link status already available from physical Ethernet adapters. The partition management firmware identifies a physical adapter that is associated with, and is being used by, a set of virtual adapters. The partition management firmware identifies a link status of the physical adapter, and sends the link status to the set of associated virtual adapters to be the link status of each virtual adapter in the set of virtual adapters.

A virtual Ethernet adapter's ability to show link status notification similar to the ability of a physical Ethernet adapter to show link status notification has programmatic and administration advantages. The upper layers of logical partitions, or applications using the communication link to outside networks, no longer need to be modified to work around the absence of such notifications from virtual Ethernet adapters. High-availability solutions can continue to use the methods developed for handling failures of physical Ethernet adapter and failure of physical links, when communicating using virtual Ethernet adapters.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Increasingly large symmetric multi-processor data processing systems, such as IBM eServer P690, available from International Business Machines Corporation, DHP9000 Superdome Enterprise Server, available from Hewlett-Packard Company, and the Sunfire 15K server, available from Sun Microsystems, Inc. are not being used as single large data processing systems. Instead, these types of data processing systems are being partitioned and used as smaller systems. These systems are also referred to as logical partitioned (LPAR) data processing systems. A logical partitioned functionality within a data processing system allows multiple copies of a single operating system or multiple heterogeneous operating systems to be simultaneously run on a single data processing system platform. A partition, within which an operating system image runs, is assigned a non-overlapping subset of the platforms resources. These platform allocatable resources include one or more architecturally distinct processors with their interrupt management area, regions of system memory, and input/output (I/O) adapter bus slots. The partition's resources are represented by the platform's firmware to the operating system image.

Each distinct operation system or image of an operating system running within a platform is protected from each other such that software errors on one logical partition cannot affect the correct operations of any of the other partitions. This protection is provided by allocating a disjointed set of platform resources to be directly managed by each operating system image and by providing mechanisms for insuring that the various images cannot control any resources that have not been allocated to that image. Furthermore, software errors in the control of an operating system's allocated resources are prevented from affecting the resources of any other image. Thus, each image of the operating system or each different operating system directly controls a distinct set of allocatable resources within the platform.

With respect to hardware resources in a logical partitioned data processing system, these resources are disjointly shared among various partitions. These resources may include, for example, input/output (I/O) adapters, memory DIMMs, non-volatile random access memory (NVRAM), and hard disk drives. Each partition within an LPAR data processing system may be booted and shut down over and over without having to power-cycle the entire data processing system.

It is important to note that while the illustrative embodiment has been described in the context of a fully functioning data processing system, those of ordinary skill in the art will appreciate that the processes of the illustrative embodiment are capable of being distributed in the form of a computer readable medium of instructions and a variety of forms and that the illustrative embodiment applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing adapters in a logical partitioned data processing system, the computer implemented method comprising:
identifying, by a partition management firmware, a physical adapter being associated with a set of virtual adapters in the logical partitioned data processing system;
identifying, by the partition management firmware, a link status of the physical adapter; and
responsive to the partition management firmware identifying the link status of the physical adapter indicating a failure in the physical adapter, sending the link status of the physical adapter to the set of virtual adapters to be the link status of the each virtual adapter in the set of virtual adapters.

2. The method of claim 1, wherein the physical adapter is a physical Ethernet adapter, wherein the link status of the physical adapter is a link status of the physical Ethernet adapter, wherein the set of virtual adapters is a set of virtual Ethernet adapters, and wherein the link status of the each virtual adapter is a link status of each virtual Ethernet adapter in the set of virtual Ethernet adapters.

3. The method of claim 2, wherein each of a plurality of virtual Ethernet adapters is located on a separate one of a plurality of logical partitions, and wherein the plurality of logical partitions is connected to the partition management firmware.

4. The method of claim 1, wherein the physical adapter and the set of virtual adapters are associated using a bridge.

5. The method of claim 4, wherein the bridge is a virtual Ethernet bridge, and wherein the bridge and the physical adapter are located on a dedicated logical partition.

6. The method of claim 1, wherein an upper layer of a logical partition polls a virtual adapter from the set of virtual adapters for the link status of the virtual adapter.

7. The method of claim 6, wherein the upper layer uses the link status of the virtual adapter to determine a status of a link to a network.

8. A computer program product comprising a computer usable medium including computer usable code for managing adapters in a logical partitioned data processing system, the computer program product comprising:
computer usable code for identifying, by a partition management firmware, a physical adapter being associated with a set of virtual adapters in the logical partitioned data processing system;
computer usable code for identifying by the partition management firmware, a link status of the physical adapter; and
responsive to the partition management firmware identifying the link status of the physical adapter indicating a failure in the physical adapter, computer usable code for sending the link status of the physical adapter to the set of virtual adapters to be the link status of the each virtual adapter in the set of virtual adapters.

9. The computer program product of claim 8, wherein the physical adapter is a physical Ethernet adapter, wherein the link status of the physical adapter is a link status of the physical Ethernet adapter, wherein the set of virtual adapters is a set of virtual Ethernet adapters, and wherein the link status of the each virtual adapter is a link status of each virtual Ethernet adapter in the set of virtual Ethernet adapters.

10. The computer program product of claim 9, wherein each of a plurality of virtual Ethernet adapters is located on a separate one of a plurality of logical partitions, and wherein the plurality of logical partitions is connected to the partition management firmware.

11. The computer program product of claim 8, wherein the physical adapter and the set of virtual adapters are associated using a bridge.

12. The computer program product of claim 11, wherein the bridge is a virtual Ethernet bridge, and wherein the bridge and the physical adapter are located on a dedicated logical partition.

13. The computer program product of claim 8, wherein an upper layer of a logical partition polls a virtual adapter from the set of virtual adapters for the link status of the virtual adapter.

14. The computer program product of claim 13, wherein the upper layer uses the link status of the virtual adapter to determine a status of a link to a network.

15. A data processing system for managing adapters in a logical partitioned data processing system, the data processing system comprising:
a storage device, wherein the storage device stores computer usable program code; and
a processor, wherein the processor executes the computer usable program code for identifying, by a partition management firmware, a physical adapter being associated with a set of virtual adapters in the logical partitioned data processing system;
computer usable program code for identifying by the partition management firmware, a link status of the physical adapter; and
responsive to the partition management firmware identifying the link status of the physical adapter indicating a failure in the physical adapter, computer usable program code for sending the link status of the physical adapter to the set of virtual adapters to be the link status of the each virtual adapter in the set of virtual adapters.

16. The data processing system of claim 15, wherein the physical adapter is a physical Ethernet adapter, wherein the link status of the physical adapter is a link status of the physical Ethernet adapter, wherein the set of virtual adapters is a set of virtual Ethernet adapters, and wherein the link status of the each virtual adapter is a link status of each virtual Ethernet adapter in the set of virtual Ethernet adapters.

17. The data processing system of claim 16, wherein each of a plurality of virtual Ethernet adapters is located on a separate one of a plurality of logical partitions, and wherein the plurality of logical partitions is connected to the partition management firmware.

18. The data processing system of claim 15, wherein the physical adapter and the set of virtual adapters are associated using a virtual Ethernet bridge, and wherein the bridge and the physical adapter are located on a dedicated logical partition.

19. The data processing system of claim 15, wherein an upper layer of a logical partition polls a virtual adapter from the set of virtual adapters for the link status of the virtual adapter.

20. The data processing system of claim 19, wherein the upper layer uses the link status of the virtual adapter to determine a status of a link to a network.
